(19) United States
(12) Patent Application Publication
(10) Pub. No.: US 2012/0046378 A1
(43) Pub. Date: Feb. 23, 2012

(54) Water-Based Digital Ink

(76) Inventor: Donald D. Sloan, Platte City, MO (US)

(21) Appl. No.: 12/860,640

(22) Filed: Aug. 20, 2010

(51) Int. Cl. C08F 2/46

(52) U.S. Cl. 522/75; 522/86; 522/79

(57) ABSTRACT

Water-based digital inks that exhibit broad adhesion and high-elongation characteristics are provided. The inks are capable of curing by various mechanisms such as through exposure to UV light and/or catalytic reactions resulting from the evaporation of water from the ink.

### BACKGROUND OF THE INVENTION

The present invention is generally directed toward a water-based digital ink system that exhibits broad adhesion and high-elongation characteristics, and is capable of curing by various mechanisms such as through exposure to UV light and/or catalytic reactions resulting from the evaporation of water from the ink.

### SUMMARY OF THE INVENTION

In one embodiment according to the present invention, there is provided a water-based ink system designed for use with an inkjet printer. The water-based ink comprises water, one or more organic solvents, one or more polymer resins selected from the group consisting of acrylic polymers, aliphatic polyurethanes, and aliphatic polyester polyurethanes, one or more photoinitiators, and a pigment. In particular embodiments, the ink system when cured is capable of elongating by between about 100% to about 500% during handling of the substrate upon which it is applied that results in stretching of the substrate. Other embodiments of ink systems according to the present invention may optionally comprise a crosslinking compound, such as a crosslinking compound selected from the group consisting of amine, aziridine, and carbodiimide compounds.

### DETAILED DESCRIPTION OF THE PREFERRED EMBODIMENT

The present invention is generally directed toward a water-based ink that is particularly suited for use as a digital printing ink. The ink generally exhibits excellent adhesion to a wide range of substrates, including both synthetic resin substrates (i.e., plastics), metallic substrates, and textiles (woven and non-woven). The ink is also exhibits high elongation characteristics making it particularly suitable for use in applications which require the ink to elongate or stretch along with the substrate to which it is applied. In certain embodiments according to the present invention, the ink exhibits the ability to cure upon exposure to UV light or through a catalytic reaction. In certain embodiments, it is possible to employ both curing methods to achieve a rapidly drying system. In these systems, the UV reaction is triggered by exposure of the ink to UV light. The UV reaction may even be initiated by exposure to ambient light, although, the reaction may not progress as quickly as if it were exposed to a UV light source. As the UV reaction progresses, the removal of water, either by forced air or natural evaporation, triggers the catalytic reaction which then scavenges the photoinitiator left in the ink system. These various functionalities and characteristics are explained in further detail below.

Ink systems according to the present invention generally exhibit excellent adhesion to a variety of rigid and flexible substrates. Exemplary substrates include polyolefins such as polyethylene and HDPE, fluted polyolefins such as fluted polyethylene available under the name COROPLAST, polycarbonate, acrylonitrile-butadiene-styrene (ABS), PETG, rigid vinyl, pressure sensitive vinyl, vinyl films, acrylics, coated and uncoated paper, top-coated and print-treated polyesters, polystyrene, polyethylene coated card stock, PVC, expanded foam PVC such as Sintra®, Celtec®, and foam board. In a particular embodiment, the vinyl and other flexible films upon which the ink system is printed may be used in the construction of vehicle wraps and fleet marks. The ability of the ink to elongate along with the substrate to which it is applied makes the ink suitable for use in those applications requiring stretching of the film over curved or protruding elements on a vehicle's skin, such as rivets. The same ink compositions which strongly adhere to the various synthetic resin substrates may also adhere very well to metallic substrates such as aluminum, steel, stainless steel, and other substrates such as ceramics and glass.

The present ink is a water-based system comprising at least about 45% by weight water. In other embodiments, the ink comprises between about 50% to about 80% by weight water, or between about 55% to about 60% by weight water. The water may be added to the system as deionized water or it may be provided in aqueous dispersions or emulsions of other components of the ink (e.g., resin dispersions) as described below. The ink formulations according to the present invention may also comprise very low concentrations of volatile organic compounds. In certain embodiments, the VOC level is below about 5%, or below about 3%, or below about 2% based on the weight of the ink.

Certain ink formulations according to the present invention also contain one or more organic solvents. In certain embodiments, the organic solvent is selected from the group consisting of ester alcohols, dibasic esters, glycols, and lactams, and mixtures thereof. An exemplary ester alcohol is 2,2,4-trimethyl-1,3-pentanediol monoisobutyrate, available as TEXANOL from Eastman Chemical. Exemplary dibasic esters include dimethyl glutarate, dimethyl succinate, and dimethyl adipate, and mixtures thereof. Exemplary glycols include triethylene glycol and propylene glycol. Exemplary lactams include 5-member ring lactams such as N-methyl-2-pyrrolidone and N-vinyl pyrrolidone. Other lactams that may be used with the present invention include N-vinyl caprolactam. The one or more organic solvents may be used at a level of between about 1% to about 25% by weight, or between about 2% to about 20% by weight, or even between about 5% to about 15% by weight. Organic solvents employed in ink formulations preferably have a high renewables content, meaning that the carbon content of the solvent is derived from a renewable sources, as opposed to a fossil fuel.

The ink system comprises one or more polymeric resins. In certain embodiments, the resin is selected from the group consisting of acrylic polymers, aliphatic polyurethanes, and aliphatic polyester polyurethanes. The resins employed with ink systems according to the present invention comprise some carboxyl functionality which facilitates crosslinking thereof. Exemplary acrylic polymers include the NEOCRYL acrylic emulsions, and particularly NEOCRYL A-1127, available from DSM NeoResins, The Netherlands. Exemplary aliphatic polyurethane polymers include the NEOREZ polymer dispersions, particularly NEOREZ R-972, available from DSM NeoResins, The Netherlands, and BAYHYDROL polyurethane dispersions, particularly BAYHYDROL UV2282, from Bayer Material Science. Exemplary aliphatic polyester polyurethane resins include ALBERDINGK® LUX 2411, which is an aqueous, anionic, UV-crosslinkable dispersion based on aliphatic polyester polyurethane. The polymeric resin may be present in the ink system at a level of between about 5% to about 40%, or between about 7% to about 35%, or between about 10% to about 30%, based on the weight of the entire ink. Note, that many of the resins are supplied as dispersions or emulsions. The foregoing percentages factor in only the solids content of the dispersions or emulsions.

In certain embodiments, the UV-curable resin is substantially entirely mono-functional. In these embodiments, the use of multi-functional resins, such as di- and tri-functional resins, is to be avoided. The molecular weight of UV-curable resin plays an important role in the overall functionality of the ink system. Generally, the lower the molecular weight of the resin, the slower the cure speed of the ink. In certain embodiments, the UV-curable resin has a molecular weight of between about 800 to about 1 million. In other embodiments, the UV-curable resin has a molecular weight of between about 1,000 to 100,000. In still other embodiments, the UV-curable resin has a molecular weight of between about 2,000 to about 50,000.

The present ink systems can also exhibit excellent storage stability, on the order of at least 4 months, or even at least 6 months. Upon extended storage conditions, the ink systems do not gel, retain the physical properties described herein, and/or otherwise remain suitable for ink jet printing applications. The inks may be packaged in containers under a nitrogen blanket or atmosphere thereby even further reducing the deleterious effects of oxygen on the ink system and extending the ink's shelf-life.

Certain embodiments according to the present invention also employ one or more optional crosslinking compounds. The crosslinking compound reacts with the carboxyl functional group of the polymeric resin. In certain embodiments, the crosslinking compound is selected from the group consisting of aziridines, carbodiimides, amine compounds such as urea formaldehyde compounds and melamine formaldehyde compounds, and combinations thereof. The crosslinking compound may be present at a level of between about 0 to about 10% by weight of the ink formulation, or between about 0.5 to about 5% by weight.

Aziridines are organic compounds containing the aziridine functional group, a three-membered heterocycle with one amine group and two methylene groups. An exemplary aziridine compound is XAMA 7 available from Ichemco, Italy. XAMA 7 is a polyfunctional aziridine compound having the general formula:

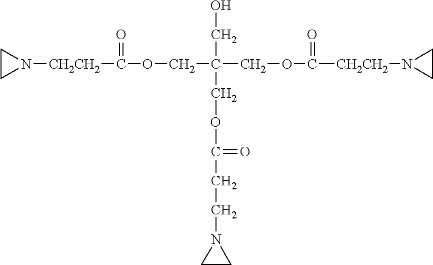

Aziridines react with carboxyl groups, such as those which are present in the polymeric resins used with certain embodiments of the present inventions according to the mechanism below:

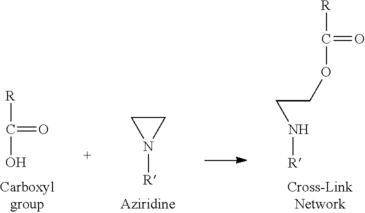

A carbodiimide is a compound generally comprising the formula RN═C═NR′. An exemplary polycarbodiimide crosslinking compound is PICASSIAN XL-702, available from Picassian Polymers, USA. PICASSIAN XL-702 is a VOC-free aqueous polycarbodiimide dispersion having a solids content of about 40%, a pH of about 11.5, and a density of about 1.04 g/cm³ at room temperature. Polycarbodiimides generally react with carboxyl functional polymers according to the following mechanism:

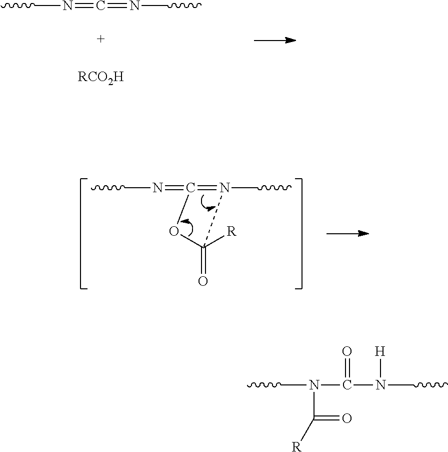

Multifunctional polycarbodiimide crosslinking compounds may also be employed in a manner very similar to mono-functional polycarbodiimides and also react with carboxyl functional polymers according to the following mechanism:

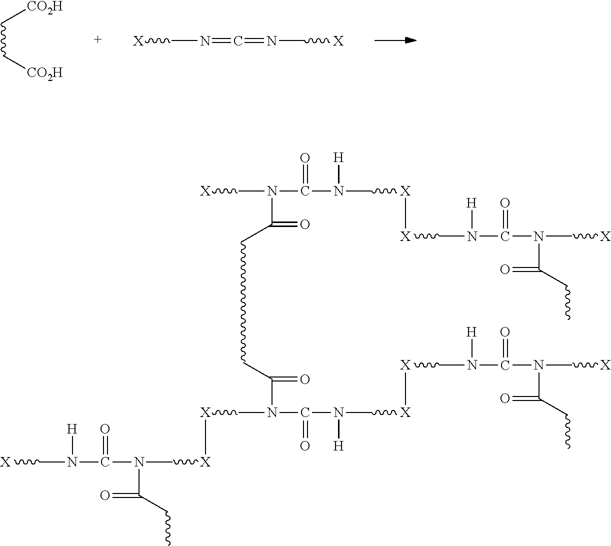

Note, the X functional group provides further crosslinking. Further description regarding multifunctional polycarbodiimide crosslinking compounds may be found in U.S. Pat. No. 5,258,481, incorporated by reference herein in its entirety.

As noted above, ink formulations according to the present invention can cure by exposure to UV light or through solvent evaporation. In order to facilitiate UV-curing, a photoinitiator may be employed. Any photoinitiator compatible with water-based inks may be used. However, in certain embodiments, photoinitiators that absorb UV light most effectively within the wavelength range of 280-310 nm are used. One exemplary photoinitiator is 1-[4-(2-Hydroxyethoxy)-phenyl]-2-hydroxy-2-methyl-1-propane-1-one, available from Ciba Specialty Chemicals, Inc. as IRGACURE 2959.

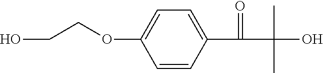

Other exemplary photoinitiators include 2,4,6 trimethylbenzoyldiphenyl phosphine oxide, 2-hydroxy-2-methyl-1-phenyl-propanone, oligo (2-hydroxy-2-methyl-1-(4-(1-methylvinyl)vinyl) propanone), and 2,4,6-trimethylbenzophonone. In certain embodiments, the photoinitiator is a blend of these compounds and is available as ESACURE KTO 46 from Lamberti Spa, Italy. The photoinitiator may be present in the ink in an amount of between about 0.1% to about 15% by weight, or between about 0.5% to about 10% by weight.

In certain embodiments, the crosslinking compound begins reacting with the carboxyl functional groups of the polymeric resin as soon as water begins to leave the ink system, and will continue reacting until the ink is fully cured. Due to the presence of the photoinitiator, the curing process may also commence when the ink is exposed to a source of UV light. Because exposure to UV light is not essential to the curing of the ink, any unreacted photoinitiator in the ink system can function as a plasticizer to improve the adhesion and flexibility of the cured ink.

Ink systems according to the present invention generally do not comprise dyes, but rather pigments for providing the desired color for the ink. The pigments utilized are generally water-dispersible pigments and are present in an amount of between about 1% to about 15% by weight, or between about 2% to about 10% by weight based on the weight of the ink. Exemplary pigments include the HOSTAJET PT and ST line of aqueous nano-dispersed pigment preparations available from Clariant Corporation, Coventry, R.I.

Various other components may also be present in the ink formulations such as wetting and leveling surfactants, defoamers, and slip and scratch resistance additives. Exemplary surfactants include polyether modified polydimethylsiloxane available as BYK 348 from BYK Additives and Instruments, and ethoxylated nonionic fluorosurfactant, available as ZONYL FSO from DuPont. Surfactants may be present in the ink formulations in an amount of between 0% to about 5% by weight, or between about 0.1% to about 2.5% by weight. Exemplary defoamers are those compositions comprising a blend of polyoxalkylene compounds, free of mineral oil and silicone, such as DEEFO 123 from Münzing, Bloomfield, N.J. Defoamers may be present in the ink formulations at a level of between 0% to about 5% by weight, or between about 0.1% to about 2.5% by weight. An exemplary slip and scratch resistance additive is TEGO GLIDE 482 from Evonik Tego Chemie GmbH. The slip and scratch resistance additive may be present in the ink formulations at a level of between 0% to about 2.5% by weight, or between about 0.1 to about 1% by weight.

Generally, ink compositions according to the present invention have a viscosity at 25° C. of between about 3 to about 25 cP, or between about 5 to about 20 cP, or between about 7 to about 15 cP. The ink compositions also have a pH of between about 6.5 to about 9, or between about 7.5 to about 8.5. In addition to these physical characteristics, the ink compositions also exhibit a number of excellent performance characteristics when cured on a particular substrate.

In certain embodiments, ink formulations according to the present invention have excellent adhesion characteristics as determined by ASTM D3359-08 Standard Test Methods for Measuring Adhesion by Tape Test. Generally, this test method involves applying a layer of ink to a particular substrate, creating a lattice pattern of cuts in the cured ink, applying a pressure-sensitive tape over the lattice, and removing the lattice. Performance is then judged by how much, if any, of the ink was removed from the lattice by the tape. In particular embodiments according to the present invention, less than 5% of the ink is removed by the tape, and more preferably, none of the ink is removed by the tape. In this particular test, the ink is deposited on the substrate to form a film of at least 0.5 mil thickness. The substrate used in the adhesion test may vary from rigid plastic substrates like polyethylene, polycarbonate, corrugated polyethylene, flexible vinyl films such as those used for vehicle wraps, and metallic substrates.

Ink systems according to the present invention also exhibit excellent weatherability characteristics. A xenon-arc weatherometer can be used to test the weatherability characteristics of the ink systems according to ASTM D4459. Generally, the ink systems may undergo 1 year of simulated weathering with less than a 10% loss of gloss or color drift. In other embodiments, the ink systems may undergo 2 or even 3 years of simulated weather with less than 10% loss of gloss or color drift.

Ink systems according to the present invention also exhibit excellent performance in environments that are generally corrosive to metals. ASTM G85-09 Standard Practice for Modified Salt Spray (Fog) Testing describes one test that can be performed to assess these qualities. In this test a scratch or scribed line is created through the coating to expose the underlying metal, such as steel, stainless steel, or aluminum. The sample is then exposed to salt-water in accordance with the test procedures, or alternatively, to deionized water in the same manner. After an exposure time of 96 hours, no lifting of the ink (i.e., separation of the ink from the metallic substrate) adjacent to the scratch line should be observable to the naked eye.

As noted above, inks according to the present invention exhibit excellent elongation or stretching characteristics. Further, not only does this characteristic apply to inks adhered to plastic substrates, but to inks adhered to metallic substrates as well. One test for determining the flexibility of an ink applied to a metal is the T-Bend Flexibility Test, such as described in ASTM D4145. In this test, a coated metal test strip (coating at least 0.5 mil thick) is folded over itself-Simple method for determining the flexibility of coatings by bending a coated metal test strip over itself one or more times. In certain embodiments, following this test there are no cracks in the ink that are observable to the naked eye.

In certain embodiments according to the present invention, the ink systems also exhibit excellent impact resistance, particularly as measured by ASTM D2794. In this test, a panel containing an ink layer (at least 0.5 mil thick) is placed beneath a vertical guide tube down which falls a weight fitted with a handle which protrudes through a vertical slot in the tube. A graduated inch-pound scale is marked along the length of the tube. The weight is raised to a certain level on the graduated tube and dropped onto the panel. The weight can be dropped onto either the coated side or the reverse side of the test panel, although impact on the reverse side general is the more severe test. The coated panel is inspected for cracking. Certain ink systems according to the present invention, when cured on a substrate, do not exhibit cracking visible to the naked eye after a weight is dropped from the 180 inch-pound graduation, even when dropped onto the reverse side of the test panel.

Certain ink systems according to the present invention also exhibit excellent water resistance. For example, when cured upon a polycarbonate or a vinyl substrate, the coated substrate (at least 0.5 mil thick ink layer) is capable of being immersed in water at ambient temperature for 96 hours without any signs of blistering visible to the naked eye. Certain ink systems according to the present invention also exhibit excellent solvent resistance. In one embodiment, the ink system, when cured upon a polycarbonate or vinyl substrate as described above, can be immersed in an organic solvent such as an alcohol (e.g., ethanol, isopropyl alcohol) or an aliphatic hydrocarbon such as hexane for 24 hours without any signs of blistering visible to the naked eye.

Certain ink embodiments according to the present invention exhibit a highly practical advantage over other conventional water-based inks, namely to be used in a digital printing press that previously utilized solvent-based inks. Generally, digital printing presses that initially used solvent-based inks could not readily be converted to utilize water-based inks, as such a conversion would likely permanently foul the inkjet heads. However, the unique formulation of the present water-based digital ink systems permits use of the present inks in digital presses that previously ran solvent-based, or other non-water based UV-curable inks, upon flushing of the old ink out of the system.

### EXAMPLES

The following examples set forth exemplary ink compositions in accordance with the present invention. It is to be understood, however, that these examples are provided by way of illustration and nothing therein should be taken as a limitation upon the overall scope of the invention.

### Example 1

| | | |
|---|---|---|
| Deionized water | solvent | 19.15 |
| N-Methyl-2 | solvent | 10 |
| Pyrrolidone | | |
| Dibasic Ester | solvent | 5 |
| NeoRez R-972 | resin (aliphatic polyurethane) | 20 |
| Alberdingk | UV resin (aliphatic polyester polyurethane) | 20 |
| LUX 2411 | | |
| Irgacure 2959 | photoinitiator (1-[4-(2-Hydroxyethoxy)- | 3 |
| | phenyl]-2-hydroxy-2-methyl-1-propane-1-one) | |
| DeeFo123 | defoamer | 0.5 |
| BYK 348 | wetting and leveling surfactant (polyether | 0.5 |
| | modified polydimethylsiloxane) | |
| Zonyl FSO | wetting and leveling surfactant (ethoxylated | 0.5 |
| | nonionic fluorosurfactant) | |
| Tego Glide 482 | slip and scratch resistance additive | 0.35 |
| Hostajet EPT | pigment dispersion | 20 |
| Magenta | | |
| Xama 7 | crosslinker (aziridine) | 1 |

### Example 2

| | | |
|---|---|---|
| Deionized water | solvent | 15.15 |
| N-Methyl-2 | solvent | 10 |
| Pyrrolidone | | |
| Dibasic Ester | solvent | 5 |
| NeoRez R-972 | resin (aliphatic polyurethane) | 20 |
| Alberdingk | UV resin (aliphatic polyester polyurethane) | 20 |
| LUX 2411 | | |
| Irgacure 2959 | photoinitiator (1-[4-(2-Hydroxyethoxy)- | 3 |
| | phenyl]-2-hydroxy-2-methyl-1-propane-1-one) | |
| DeeFo123 | defoamer | 0.5 |
| BYK 348 | wetting and leveling surfactant (polyether | 0.5 |
| | modified polydimethylsiloxane) | |
| Zonyl FSO | wetting and leveling surfactant (ethoxylated | 0.5 |
| | nonionic fluorosurfactant) | |
| Tego Glide 482 | slip and scratch resistance additive | 0.35 |
| Hostajet EPT | pigment dispersion | 20 |
| Magenta | | |
| XL-702 | crosslinker (polycarbodiimide) | 5 |

### Example 3

| | | |
|---|---|---|
| Deionized water | solvent | 19.15 |
| N-Methyl-2 | solvent | 10 |
| Pyrrolidone | | |
| Dibasic Ester | solvent | 5 |
| NeoCryl A-1127 | resin (acrylic emulsion) | 20 |
| Alberdingk | UV resin (aliphatic polyester polyurethane) | 20 |
| LUX 2411 | | |
| Irgacure 2959 | photoinitiator (1-[4-(2-Hydroxyethoxy)- | 3 |
| | phenyl]-2-hydroxy-2-methyl-1-propane-1-one) | |
| DeeFo123 | defoamer | 0.5 |
| BYK 348 | wetting and leveling surfactant (polyether | 0.5 |
| | modified polydimethylsiloxane) | |
| Zonyl FSO | wetting and leveling surfactant (ethoxylated | 0.5 |
| | nonionic fluorosurfactant) | |
| Tego Glide 482 | slip and scratch resistance additive | 0.35 |
| Hostajet EPT | pigment dispersion | 20 |
| Magenta | | |
| Xama 7 | crosslinker (aziridine) | 1 |

### Example 4

| | | |
|---|---|---|
| Deionized water | solvent | 15.15 |
| N-Methyl-2 | solvent | 10 |
| Pyrrolidone | | |
| Dibasic Ester | solvent | 5 |
| NeoCryl A-1127 | resin (acrylic emulsion) | 20 |
| Alberdingk | UV resin (aliphatic polyester polyurethane) | 20 |
| LUX 2411 | | |
| Irgacure 2959 | photoinitiator (1-[4-(2-Hydroxyethoxy)- | 3 |
| | phenyl]-2-hydroxy-2-methyl-1-propane-1-one) | |
| DeeFo123 | defoamer | 0.5 |
| BYK 348 | wetting and leveling surfactant (polyether | 0.5 |
| | modified polydimethylsiloxane) | |
| Zonyl FSO | wetting and leveling surfactant (ethoxylated | 0.5 |
| | nonionic fluorosurfactant) | |
| Tego Glide 482 | slip and scratch resistance additive | 0.35 |
| Hostajet EPT | pigment dispersion | 20 |
| Magenta | | |
| XL-702 | crosslinker (polycarbodiimide) | 5 |

### Example 5

| | | |
|---|---|---|
| Deionized water | solvent | 10.65 |
| N-Methyl-2 | solvent | 10 |
| Pyrrolidone | | |
| Texanol Ester | solvent (2,2,4-trimethyl-1,3-pentanediol | 2 |
| Alcohol | mono(2-methylpropanoate)) | |
| NeoCryl A-1127 | resin (acrylic emulsion) | 27 |
| Bayhydrol | UV resin (urethane acrylate) | 27 |
| UV2282 | | |
| Esacure KTO 46 | photoinitiator blend | 2.5 |
| | (2,4,6 trimethylbenzoyldiphenyl phosphine | |
| | oxide, 2-hydroxy-2-methyl-1-phenyl- | |
| | propanone, oligo (2-hydroxy-2-methyl-1 (4-(1- | |
| | methylvinyl)vinyl) propanone), and 2,4,6- | |
| | Trimethylbenzophenone | |
| DeeFo123 | defoamer | 0.5 |
| BYK 348 | wetting and leveling surfactant (polyether | 0.5 |
| | modified polydimethylsiloxane) | |
| Zonyl FSO | wetting and leveling surfactant (ethoxylated | 0.5 |
| | nonionic fluorosurfactant) | |
| Tego Glide 482 | slip and scratch resistance additive | 0.35 |
| Hostajet EPT | pigment dispersion | 14 |
| Magenta | | |
| XL-702 | crosslinker (polycarbodiimide) | 5 |

### Example 6

| | | |
|---|---|---|
| Deionized water | solvent | 9.65 |
| N-Methyl-2 | solvent | 10 |
| Pyrrolidone | | |
| Texanol Ester | solvent (2,2,4-trimethyl-1,3-pentanediol | 2 |
| Alcohol | mono(2-methylpropanoate)) | |
| NeoCryl A-1127 | resin (acrylic emulsion) | 30 |
| Bayhydrol | UV resin (urethane acrylate) | 30 |
| UV2282 | | |
| KTO 46 | photoinitiator blend | 2.5 |
| | (2,4,6 trimethylbenzoyldiphenyl phosphine | |
| | oxide, 2-hydroxy-2-methyl-1-phenyl- | |
| | propanone, oligo (2-hydroxy-2-methyl-1(4-(1- | |
| | methylvinyl)vinyl) propanone), and 2,4,6- | |
| | trimethylbenzophonone | |
| DeeFo123 | defoamer | 0.5 |
| BYK 348 | wetting and leveling surfactant (polyether | 0.5 |
| | modified polydimethylsiloxane) | |
| Zonyl FSO | wetting and leveling surfactant (ethoxylated | 0.5 |
| | nonionic fluorosurfactant) | |
| Tego Glide 482 | slip and scratch resistance additive | 0.35 |
| Hostajet EPT | pigment dispersion | 14 |
| Magenta | | |

The table below summarizes the general composition of certain ink formulations made in accordance with the present invention:

| | Broad range | Narrow range |
|---|---|---|
| Component | (% by weight) | (% by weight) |
| Water | 50-80% | 55-60% |
| Organic solvent(s) | 1-25% | 5-15% |
| Resin(s) | 5-40% | 10-30% |
| Pigment | 1-15% | 2-10% |
| Crosslinker(s) | 0-10% | 0.5-5% |
| Photoinitiator(s) | 0.1-15% | 0.5-10% |
| Defoamer(s) | 0-5% | 0.1-2.5% |
| Surfactant(s) | 0-5% | 0.1-2.5% |
| Slip/Scratch | 0-2.5 | 0.1-1% |
| resistance additive | | |

1. A water-based ink for use with inkjet printers comprising:
water;
one or more organic solvents;
one or more acrylic polymers,
one or more polymer resins selected from the group consisting of aliphatic polyurethanes and aliphatic polyester polyurethanes;
one or more photoinitiators; and
a pigment,
wherein said ink when cured is capable of elongating by between about 100% to about 500% during handling of the substrate upon which it is applied that results in stretching of the substrate.

2. The water-based ink according to claim 1, wherein said ink comprises at least about 45% by weight water.

3. The water-based ink according to claim 1, wherein said ink further comprises one or more crosslinking compounds operable to cause crosslinking of said acrylic polymers and one or more polymer resins, said crosslinking compounds selected from the group consisting of amine, aziridinc, and polycarbodiimide compounds.

4. The water-based ink according to claim 3, wherein said ink comprises between about 0.5 to about 5% by weight of said one or more crosslinking compounds.

5. The water-based ink according to claim 1, wherein said ink comprises between about 1 to about 15% by weight of said one or more organic solvents.

6. The water-based ink according to claim 1, wherein said organic solvent is selected from the group consisting of dibasic esters, glycols, and lactams.

7. The water-based ink according to claim 1, wherein said ink comprises between about 1 to about 15% by weight of said pigment.

8. The water-based ink according to claim 1, wherein said ink is capable of adhering to both plastic and metal substrates without any ink being removed, as perceptible by the naked eye, when tested according to ASTM D3359-08.

9. The water-based ink according to claim 1, wherein said ink exhibits no cracking visible to the naked eye when tested according to ASTM D2794 at a level of 180 inch-pounds.

10. The water-based ink according to claim 1, wherein said ink, when cured upon a polycarbonate or a vinyl substrate, is capable of being immersed in water for 96 hours without any signs of blistering visible to the naked eye.

11. The water-based ink according to claim 1, wherein said ink when cured onto a vinyl substrate is capable of withstanding up to 1 year of simulated weathering according to ASTM D4459 with less than a 10% color drift.

12. The water-based ink according to claim 1, wherein said ink comprises less than 5% by weight of volatile organic compounds (VOCs).

13. A water-based ink for use with inkjet printers comprising:
water;
one or more acrylic polymers,
one or more polymer resins selected from the group consisting of aliphatic polyurethanes and aliphatic polyester polyurethanes;
one or more photoinitiators; and
a pigment,
wherein said ink when cured is capable of elongating by between about 100% to about 500% during handling of the substrate upon which it is applied that results in stretching of the substrate.

14. The water-based ink according to claim 13, wherein said ink comprises at least about 45% by weight water.

15. The water-based ink according to claim 13, wherein said ink further comprises one or more crosslinking compounds operable to cause crosslinking of said acrylic polymers and one or more polymer resins, said crosslinking compounds selected from the group consisting of amine, aziridine, and polycarbodiimide compounds.

16. The water-based ink according to claim 15, wherein said comprises between about 0.5 to about 5% by weight of said one or more crosslinking compounds.

17. The water-based ink according to claim 13, wherein said ink comprises between about 1 to about 15% by weight of said pigment.

18. The water-based ink according to claim 13, wherein said ink is capable of adhering to both plastic and metal substrates without any ink being removed, as perceptible by the naked eye, when tested according to ASTM D3359-08.

19. The water-based ink according to claim 13, wherein said ink exhibits no cracking visible to the naked eye when tested according to ASTM D2794 at a level of 180 inch-pounds.

20. The water-based ink according to claim 13, wherein said ink, when cured upon a polycarbonate or a vinyl substrate, is capable of being immersed in water for 96 hours without any signs of blistering visible to the naked eye.

21. The water-based ink according to claim 13, wherein said ink when cured onto a vinyl substrate is capable of withstanding up to 1 year of simulated weathering according to ASTM D4459 with less than a 10% color drift.

22. The water-based ink according to claim 13, wherein said ink comprises less than 5% by weight of volatile organic compounds (VOCs).

23. The water-based ink according to claim 1, wherein said ink has a viscosity at 25° C. of between about 3 to about 15 cP.

24. The water-based ink according to claim 13, wherein said ink has a viscosity at 25° C. of between about 3 to about 15 cP.
